(19) United States
(12) Patent Application Publication
(10) Pub. No.: US 2016/0368347 A1
(43) Pub. Date: Dec. 22, 2016

(54) FLUID HEATING DEVICE FOR A MOTOR VEHICLE AND CORRESPONDING HEATING AND/OR AIR-CONDITIONING APPARATUS

(71) Applicant: VALEO SYSTEMES THERMIQUES, Le Mesnil Saint Denis (FR)

(72) Inventors: Frédéric PIERRON, Rambouillet (FR); Bertrand PUZENAT, Montigny-le-bretonneux (FR); Laurent TELLIER, Paris (FR); Jose Leborgne, Elancourt (FR)

(73) Assignee: VALEO SYSTEMES THERMIQUES, Le Mesnil Saint Denis (FR)

(21) Appl. No.: 14/901,815

(22) PCT Filed: Jul. 2, 2014
(86) PCT No.: PCT/EP2014/064122

§ 371 Date: Dec. 29, 2015

(30) Foreign Application Priority Data
Jul. 2, 2013 (FR) 1356418

(51) Int. Cl. B60H 1/22; H05B 3/26

(52) U.S. Cl. CPC B60H 1/2221; H05B 3/26; H05B 2203/013; H05B 2203/023; H05B 2214/02; B60H 2001/224; B60H 2001/2271

(57) ABSTRACT

The invention relates to an electric device for heating a fluid for a motor vehicle, comprising:—at least one heating module comprising a metal heating body having at least one electric heating means made in the form of a heating track on a surface of the heating body and—control means for said heating module comprising electronic and/or electrical components. According to the invention, at least one electronic and/or electrical component of the control means is arranged on the surface of the heating body having the heating track, in electrical contact with the heating track. The invention also relates to a heating and/or air conditioning apparatus comprising such a device.

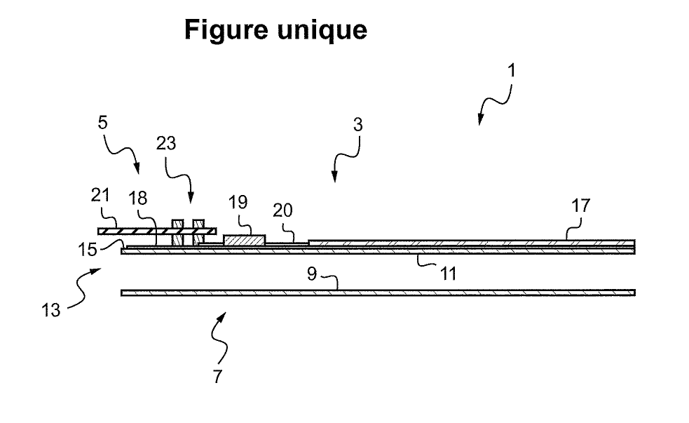

The invention relates to a device for electrically heating fluid for a motor vehicle. The invention applies more particularly to motor vehicle heating and/or air-conditioning units comprising such a heating device.

Air intended for heating the vehicle interior is usually warmed up by passing a flow of air through a heat exchanger, more specifically by exchange of heat between the flow of air and a fluid. This is generally the coolant in the case of a combustion engine.

Such a heating method may prove unsuitable or insufficient to guarantee heating of the interior of a motor vehicle as well as demisting and defrosting.

However, a method for rapidly and effectively heating up the interior of the vehicle, particularly for warming up the interior or for defrosting or demisting the vehicle prior to use in a very cold environment or even when a very rapid rise in temperature is desired.

Furthermore, in the case of an electric vehicle, the heating function is no longer performed by circulation of the coolant through the heat exchanger. However, a water circuit can be provided for heating the vehicle interior but this method of heating may likewise prove unsuitable or insufficient to guarantee rapid and effective heating of the vehicle interior.

Moreover, in order to reduce the size and cost of an additional water circuit, it is also known practice to use, for an electric vehicle, an air-conditioning loop that operates in a heat pump mode. Thus, the air-conditioning loop that conventionally allows a flow of air to be cooled using a refrigerant is used, in this case, to heat up the flow of air.

However, this method of heating may prove unsuitable or insufficient. This is because the performance of the air-conditioning loop as a heat pump is dependent on the external weather conditions. For example, when the external air temperature is too low, this air cannot be used as a source of heat energy.

One known solution is to add an additional electrical heating device to the heat exchanger or to the water circuit or even to the air-conditioning loop.

The additional electrical heating device may be suitable for the upstream heating of the fluid, such as the combustion engine coolant or the water of the electric vehicle interior heating water circuit or even the refrigerant of the air-conditioning loop.

In the known way, the additional electrical heating device comprises one or more heating modules in contact with the fluid that is to be heated.

More specifically, a heating module may comprise a heating body that can be electrically powered to form a source of heat energy, thereby defining a volume for circulation of fluid that is to be heated.

According to one known solution, a heating body has electrical heating means, for example one or more heating resistances produced by screen printing in the form of resistive tracks on a surface of the heating body.

The heating body may be of substantially flat shape, for example rectangular, or as an alternative may be produced in the form of a cylindrical jacket surrounding a core.

However, the heating body able to heat up the fluid such as water containing glycol requires a control means comprising for example a power switch to control the supply of electrical power to the heating module to which it is connected. The power switch is electrically connected to the electrical heating means such as the resistive tracks screen-printed onto the heating body, in order to allow or prevent a supply of electrical power to these electrical heating means.

The opening and/or closing of the power switch may be brought about by a microcontroller.

In addition to the power switch, the electronic and/or electrical components of the control means may notably comprise the microcontroller, electrical connection means comprising electrical connectors connecting the resistive track for example to the power switch, high-voltage power supply connectors, for example connected to the battery of the vehicle, and low-voltage connectors, for example connected to the network, referred to as the low-voltage network, of the vehicle, or even, for example, galvanic-insulation means.

The control means is generally sited remotely on an electric circuit support such as a printed circuit board, notably involving a system for connecting the resistive track on the heating body to the electric circuit support.

This therefore leads to a certain amount of bulk on the electric circuit support which has to carry all of the electronic and/or electrical components and with a plurality of conductive tracks for example on the printed circuit board, thereby increasing the risks of thermal incidents.

Moreover, the electronic and/or electrical components, and particularly the power components borne by the electric circuit support generate heat when in operation. If the electronic and/or electrical components borne by the electric circuit support exceed a maximum threshold temperature, for example of the order of 200 to 250° C., for example in the event of the intrinsic failure of a component, the latter heating up to a significant extent, there is a risk of the support catching fire as it is generally made of resin, which is flammable.

According to one known solution, an additional metallic component forming a heat sink is provided to dissipate the heat generated by the electronic and/or electrical components of the control means borne by the electric circuit support.

It is therefore an objective of the invention to at least partially alleviate these disadvantages of the prior art.

To this end, one subject of the invention is a device for electrically heating a fluid for a motor vehicle, comprising:
at least one heating module comprising a metallic heating body having at least one electrical heating means produced in the form of a heating track on a surface of the heating body,
a control means for controlling the heating module, comprising electronic and/or electrical components,

characterized in that at least one electronic and/or electrical component of the control means is arranged on the surface of the heating body, having the heating track, in electrical contact with the heating track.

According to one embodiment of the invention, said at least one electronic and/or electrical component of the control means is a power electronic and/or electrical component.

The fluid that is to be heated up which is intended to pass through the heating body is generally at most at a temperature of the order of 120° C., and the heating body, by giving up heat to this fluid, becomes cooled.

The heating body therefore performs the function of heating the fluid that is to be heated up. The heat produced by the heating track is transmitted directly to the fluid that is to be heated up, for example, according to one embodiment, through the wall of the heating body, minimizing the thermal losses and reducing the thermal inertia of the device. The fluid can be heated up rapidly.

In addition, because it bears at least some electronic and/or electrical components of the control means, the heating body also performs some of the electronic control functions in a similar way to a printed circuit board.

Finally, the heating body also acts as a heat sink for the electronic and/or electrical components it bears. Specifically, the metallic heating body, for example made of aluminum or of stainless steel, is cooled by the fluid that is to be heated, thereby allowing the heat generated by the components it bears to be removed. There is no longer any need to provide an additional component for dissipating the heat of certain electronic and/or electrical components of the control means.

Thus, all or some of the control electronics, the heating of the fluid, and the dissipation of the heat of the components of the control means attached to the heating body are combined on the one same support, in this instance the heating body.

In addition, arranging at least certain electronic and/or electrical components of the control means on the heating body in electrical contact with the heating track makes it possible to avoid systems providing the interconnections between the control electronics and the heating track.

According to the present invention, said at least one electronic and/or electrical component of the control means arranged on the surface of the heating body having the heating track is directly or indirectly in electrical contact with the heating track.

According to one embodiment, the electronic and/or electrical components are soldered to the surface of the heating body.

As an alternative, the electronic and/or electrical components are bonded to the surface of the heating body, using a thermal adhesive.

According to one aspect of the invention, the heating track is produced by screen printing. The screen printing of the heating track onto the heating body is thus put to use for relocating certain components onto the heating body, for example, using soldering or bonding.

According to one preferred embodiment, the surface of the heating body having the heating track and said at least one electronic and/or electrical component is substantially flat. By being flat, the surface of the heating body allows large-sized components, notably the power electronic components that need to be cooled, to be set out.

According to one embodiment of the invention, the heating body has a first wall and a second wall, between them defining a volume for the circulation of the fluid that is to be heated, and the surface of the heating body having the heating track is the external surface of the second wall. The heating track and the components of the control means that are relocated onto the heating body are therefore arranged outside of the volume in which the fluid that is to be heated circulates.

According to one embodiment, the heating body has at least one conducting track directly or indirectly electrically connecting the heating track and said at least one electronic and/or electrical component. The electrical connection between the heating track and at least part of the control means may be achieved in a way that is simple and not very bulky without requiring a specific connector.

The heating module may comprise a layer of electrical insulation between the heating body and the heating track, so as to avoid electrical losses.

According to another aspect of the invention, the electronic or electrical component arranged on the heating body is a power switch able to allow or prevent the supply of power to the heating means, such as a power transistor. The heat generated by such a power component can therefore be dissipated easily by the heating body itself.

According to one embodiment of the invention, the heating module comprises a thermal cut-out arranged on the heating body between the heating track and the power switch. The cut-out arranged directly on the heating body can rapidly interrupt the supply of power to the heating track in the event of anomaly as soon as the heating body reaches a predefined threshold temperature, for example of the order of 150° C., so as to avoid damage to the heating body and to the heating module comprising same.

According to one particular embodiment, the electrical heating means comprises a heating resistance produced in the form of a screen-printed resistive track.

For preference, the fluid that is to be heated is a liquid such as water or water containing glycol.

The control means may comprise a printed circuit support and the heating module comprises a connector able to connect the printed circuit support both mechanically to the heating body and electrically to said at least one electronic and/or electrical component arranged on the heating body. This additional support for the rest of the components of the control means which are not relocated to the heating body is simplified in comparison with the solutions of the prior art, and the reduction in electrical tracks and components on this support means that the risks of thermal incident can be minimized.

Said device may be arranged in a heating circuit for heating the interior of said vehicle.

The invention also relates to a heating and/or air-conditioning unit for a motor vehicle, characterized in that it comprises a heating device as defined hereinabove.

Further features and advantages of the invention will become more clearly apparent from reading the following description given by way of nonlimiting illustrative example and from studying the single FIGURE which is a schematic view of a heating module of a fluid heating device according to the invention.

The invention relates to a device 1 for electrically heating a fluid for a motor vehicle for a heating and/or air-conditioning unit.

The electrical heating device 1 is, for example, an additional heating device for heating a fluid arranged in a circuit for heating a fluid of the vehicle for heating the interior.

According to one example, the electrical heating device 1 is positioned upstream of a heat exchanger of an air-conditioning loop able to operate as a heat pump, so as to heat the refrigerant.

According to another example, the electrical heating device 1 is arranged upstream of a heat exchanger using a combustion engine coolant as heat-transfer fluid.

Such an electrical heating device 1 could also be provided upstream of a heat exchanger intended to regulate the temperature of an electrical energy storage device, sometimes termed a battery pack, for an electrically-powered or hybrid vehicle.

The electrical heating device 1 depicted comprises at least one heating module 3 and a control means 5 for controlling the supply of electrical power to the heating module 3.

Of course provision may be made for the electrical heating device to comprise a single heating module, or several heating modules, depending on the requirement.

With reference to the single FIGURE, a heating module 3 comprises a heating body 7.

The heating module 3 may be produced in the form of a housing, the heating body 7 may be of substantially parallelepipedal shape.

As an alternative, the heating module 3 may be substantially cylindrical, in which case the heating body 7 may be produced in the form of a substantially cylindrical jacket.

The heating body 7 is made of a metallic material such as aluminum or stainless steel.

According to the embodiment illustrated, the heating body 7 has two opposite walls: a first wall 9 and a second wall 11, between them defining a volume 13 for the circulation of the fluid that is to be heated. The circulation volume 13 is therefore defined between the surfaces of the two walls 9, 11 of the heating body 7 that are positioned facing each other.

The second wall 11 of the heating body 7 has an external surface 15 opposite to the circulation volume 13.

Furthermore, the heating body 7 has at least one electrical heating means produced in the form of a heating track 17. The heating track 17 is, according to the embodiment described, produced by screen printing for example on the external surface 15 of the second wall 11 of the heating body 7. However, according to one particular embodiment, the screen-printed track may be on the internal surface of the heating body. It may be a heating resistance 17. This heating resistance 17 may be produced in the form of a resistive track 17. According to the preferred embodiment, the resistive track 17 is outside of the circulation volume 13 for the fluid that is to be heated.

By virtue of this embodiment, the heat produced by the heating track 17 is transmitted directly to the fluid that is to be heated through the wall of the heating body 7, thereby minimizing thermal losses and reducing the thermal inertia of the device, which means that the fluid can therefore be heated up rapidly.

A layer of electrical insulation 18 is provided between the external surface 15 of the heating body 7 and the heating track 17.

The control means 5 controls the heating body 7 by controlling the supply of power to the heating track 17.

The control means 5 for this purpose comprises power electronic and/or electrical components including at least one power switch 19, such as a power transistor, able to allow or prevent the supply of power to the heating track 17.

The opening and/or closing of the power switch may be brought about by a microcontroller.

In addition to the power switch 19, the electronic and/or electrical components of the control means 5 may by way of nonlimiting example include the microcontroller, high-voltage power supply connectors rated at the order of 250 V to 450 V for example connected to the battery of the vehicle and configured to manage the heating power, low-voltage power supply connectors rated at the order of 12 V for managing the control of the heating, elements for galvanic insulation between the low-voltage connectors and components and the high-voltage connectors and components, such as flyback converters, allowing the passage of information between the low-voltage network and the high-voltage network, in both directions.

At least one of the electronic and/or electrical components of the control means 5 is arranged on the external surface 15 of the heating body 7. This external surface 15 is advantageously substantially flat so as to offer a large surface area on which electronic and/or electrical components can be arranged, thus allowing easy dissipation of the power of the component which can therefore always be cooled.

According to another embodiment, the surface of the heating body is cylindrical and said at least one of the electronic and/or electrical components of the control means 15 is arranged on this external surface notably via a support according to the curvature of the heating body.

More specifically, at least one of the electronic and/or electrical components of the control means 5 is arranged directly on the layer of electrical insulation 18 on the external surface 15 of the heating body 7, without the interposition of a support or a connector.

This arrangement is such that the electronic and/or electrical component or components of the control means 5 are arranged directly or indirectly in electrical contact with the screen-printed track 17. The electrical connection to the heating track 17 is achieved for example via a conducting track 20.

According to one alternative form of embodiment, all the electronic and/or electrical components of the control means 5 are arranged on the external surface 15 of the second wall 11 of the heating body 7.

Where this is not the case, at least one or several electronic and/or electrical components generating heat and requiring a heat sink, this generally being a power component such as the power switch 19, is arranged on the external surface 15 of the second wall 11 of the heating body 7.

The arrangement of a power component, such as the power switch 19, is advantageous since this component is at high voltage like the resistive track 17, making electrical connection here.

The arrangement of one or more electronic and/or electrical components of the control means 5 on the heating body 7 may be achieved by soldering or even by bonding, for example using a thermal adhesive.

In comparison with the solutions of the prior art whereby the control means is relocated away from the heating module 3, with this solution, the electronic and/or electrical components of the control means 5 can be relocated onto the heating body 7 which therefore forms a heat sink for the heat emitted by the electronic and/or electrical component or components of the control means 5 which are arranged on the surface of the heating body 7. Specifically, the heating body 7, which in operation reaches a temperature of the order of 100° C., forms a cold source for the electronic and/or electrical components which must not exceed a threshold temperature for example of the order of 150° C.

Moreover, with the fluid flow rates used, which are for example of the order of 300 l/h to 2000 l/h, the temperature of the heating body 7 is of the order of 100° C. or even 105° C., the temperatures of the electronic and/or electrical components which are arranged on the heating body 7 are therefore substantially of the order of 100 to 105° C. but remain lower than the maximum service temperatures of the electronic and/or electrical components which, for example, are of the order of 150° C.

In addition, no additional heat sink is needed to dissipate the heat generated by the electronic and/or electrical components.

Furthermore, in the event of failure of the electronic and/or electrical components arranged on the heating body 7, the risk of a thermal incident is greatly reduced because of the fact that the electronic and/or electrical components are cooled via the heating body 7 which, being made of metal, is non-flammable.

Moreover, when not all of the electronic and/or electrical components are arranged directly on the heating body 7, an electric circuit support 21 such as a printed circuit board, known by the acronym PCB, can bear the electronic and/or electrical components of the control means 5 which are not arranged on the external surface 15 of the second wall 11 of the heating body 7.

For that purpose, a connector 23 may be provided which can be connected mechanically to the heating body 7 and to the electric circuit support 21, and electrically connected, for example via a conducting track 20, to the electronic and/or electrical component(s) 19 arranged on the heating body 7.

Such an electric circuit support 21 which no longer bears some of the electronic and/or electrical components which are arranged on the heating body 7 is therefore simpler to manufacture in comparison with the solutions of the prior art in which the electric circuit support 21 bears all the components.

The electric circuit support 21 consequently has fewer electric tracks in comparison with the solutions of the prior art, and the risk of thermal incident is reduced in comparison with the solutions of the prior art.

Moreover, the resistive track 17 may be a fixed value.

As an alternative, a temperature sensor (not depicted in the FIGURE) may be provided for measuring the temperature of the heating body 7; this may be a thermistor, such as a PTC (positive temperature coefficient) probe, the resistance of which increases sharply with temperature.

In that case, the supply of power to the heating track 17 is performed on the basis of a heating instruction and of the temperature measured by the temperature sensor.

This temperature sensor may also be arranged on the heating body 7, for example being soldered, brazed or bonded to the external surface 15 of the second wall 11 of the heating body 7.

According to another alternative form, the temperature sensor may be an NTC (negative temperature coefficient) probe, the resistance of which decreases uniformly with temperature.

Furthermore, provision may be made for an electrical and/or electronic component, for example at least one thermal cut-out (not depicted in the FIGURE), to be positioned on the heating body 7 able to cut the supply of current when the temperature of the heating body 7 reaches a predefined temperature threshold that is critical to the correct operation of the heating module 3.

For that purpose, the thermal cut-out is arranged, for example, by soldering or bonding between the resistive track 17 and the power supply switch 19 or, as an alternative, between the power switch 19 and the electric circuit support 21.

The thermal cut-out (not depicted) is arranged directly on the external surface 15 of the second wall 11 of the heating body 7, therefore outside of the volume 13 for the circulation of the fluid that is to be heated.

The thermal cut-out (not depicted) is arranged directly on the external surface 15 of the second wall 11 of the heating body 7, therefore outside of the volume 13 for the circulation of the fluid that is to be heated.

The thermal cut-out (not illustrated) can be arranged on a conducting track 20 on the heating body 7.

Of course, the thermal cut-out (not depicted) is made from an electrically conducting material so as to allow it to pass current during normal operation, and is capable of at least partially melting when the region of the heating body 7 in contact with the thermal cut-out reaches a predefined temperature threshold, for example of the order of 150° C.

The material of the thermal cut-out is chosen to have an operating temperature range that is compatible with the normal operating temperature range of the heating body 7 and to have a melting point that corresponds to the critical predefined temperature threshold for the heating body 7, so as to avoid premature melting of the thermal cut-out.

In the event of overheating, which means to say in the event of the heating body 7 reaching the predefined temperature threshold, the thermal cut-out (not depicted) melts so that the electrical connection between the resistive track 17 and the power switch 19 or between the electric circuit support 21 and the power switch 19 is no longer made. The circuit supplying electrical power to the heating resistance in the form of a screen-printed track 17 is therefore open. The supply of current is interrupted.

Thus, in the event of an absence of, or too low a flow rate of the fluid, such as water containing glycol, to be heated in the circulation volume 13, since the transfer of heat with the fluid is insufficient or even nonexistent, the heating body 7 experiences an increase in temperature and the thermal cut-out (not illustrated) interrupts the supply of power to the resistive track 17 because of the rise in temperature of the heating body 7 as soon as the latter reaches the temperature threshold.

Thus, by relocating the electronic and/or electrical components that require cooling onto the metallic heating body 7, the latter acts as a radiator or heat sink to extract the heat that these electronic and/or electrical components dissipate. No additional component is needed for dissipating the heat generated by these components.

The electronic and/or electrical components arranged on the heating body 7 are always cooled by this heating body 7, and because the latter is made of metal it is non-flammable unlike a conventional electronic board. Thus, even in the event of a component installed on the heating body 7 failing, the risk of a thermal incident is minimized.

Even in the event that an electric circuit support 21 is still required, the absence of certain electronic and/or electrical components, notably of power components, and the reduction of the electrical tracks on this electric circuit support 21 makes the electric circuit support 21 simpler to manufacture and makes assembly more reliable with respect to the risks of thermal incident.

A temperature sensor may also be arranged directly on the heating body 7, thus providing an estimate of the temperature of the fluid.

Finally, a thermal cut-out may also be arranged on the heating body 7 so that the supply of power to the heating track 17 such as a resistive track 17 can be interrupted. In the event of an absence of fluid or of too low a flow rate of fluid in the fluid circulation volume 13, the thermal cut-out would not fail to interrupt the supply of power to the heating track 17 as a result of the increase in temperature of the heating body 7 before critical temperatures carrying a risk of damaging the heating body 7 are reached.

1. A device for electrically heating a fluid for a motor vehicle, comprising:
at least one heating module comprising a metallic heating body having at least one electrical heating means produced in the form of a heating track on a surface of the heating body,
a control means for controlling the heating module, comprising electronic and/or electrical components,
characterized in that at least one electronic and/or electrical component of the control means is arranged on the surface of the heating body, having the heating track, in electrical contact with the heating track.

2. The device as claimed in claim 1, in which said at least one electronic and/or electrical component of the control means is a power electronic and/or electrical component.

3. The device as claimed in claim 1, in which the heating track is produced by screen printing.

4. The device as claimed according to claim 1, in which the surface of the heating body having the heating track and said at least one electronic and/or electrical component is substantially flat.

5. The device as claimed according to claim 1, in which the heating body has a first wall and a second wall, between them defining a volume for the circulation of the fluid that is to be heated, and in which device the surface of the heating body having the heating track is the external surface of the second wall.

6. The device according to claim 1, in which the heating body has at least one conducting track electrically connecting the heating track and said at least one electronic and/or electrical component.

7. The device according to claim 1, in which the electronic or electrical component arranged on the heating body is a power switch able to allow or prevent the supply of power to the heating means, such as a power transistor.

8. The device as claimed in claim 6, in which the heating module comprises a thermal cut-out arranged on the heating body between the heating track and the power switch.

9. The device according to claim 1, in which the electrical heating means comprises a heating resistance produced in the form of a screen-printed resistive track.

10. The device according to claim 1, in which the control means comprises a printed circuit support and in which the heating module comprises a connector able to connect the printed circuit support both mechanically to the heating body and electrically to said at least one electronic and/or electrical component arranged on the heating body.

11. The device according to claim 1, arranged in a heating circuit for heating the interior of said vehicle.

12. A heating and/or air-conditioning unit for a motor vehicle, characterized in that it comprises at least one electrical heating device according to claim 1.
